(19) United States
(12) Patent Application Publication
(10) Pub. No.: US 2004/0093157 A1
(43) Pub. Date: May 13, 2004

(54) Method for linking geographical and commercial data and providing the same

(76) Inventors: Jurgen W. Muller, Wohnsitz Darmstadt (DE); Kurt Friedrich, Wohnsitz Modaulal-Brandau (DE)

Correspondence Address: SQUIRE, SANDERS & DEMPSEY L.L.P, 600 HANSEN WAY, PALO ALTO, CA, 94304-1043, US

(21) Appl. No.: 10/332,793

(22) PCT Filed: Jul. 9, 2001
(86) PCT No.: PCT/DE01/02556

(30) Foreign Application Priority Data
Jul. 13, 2000 (DE) 100 34 109.8

(51) Int. Cl. G01C 21/26

(52) U.S. Cl. 701/213; 701/214; 342/357.1

(57) ABSTRACT

The invention concerns a method for accurately determining the position of geographical measuring points and linking the data of these measuring points with further data as well as making the data thus linked available in electronic form. First, geographical measuring points are designated on site and the corresponding coordinates of these measuring points are determined. Following this, a real marker, for example in the form of a seal, or a virtual marker is assigned to each measuring point. The address data of the measuring points and the corresponding coordinates is then stored in a database (2). This data is supplemented with further commercial data, such as for example product and/or service information, and is made available for use to a client who communicates with the database (2) using, for example, a transmitting and receiving device (1).

### TECHNICAL FIELD OF THE INVENTION

The invention concerns a method for accurately determining the position of geographical measuring points and linking the data of these measuring points with further data as well as making the data thus linked available in electronic form.

### PRIOR ART

Similar methods are already known from prior state of the art. The WO 98/59215, for example, describes a personal communication device that contains a GPS (Global Positioning System) receiver and a display. With this device, a user can request a desired map as well as further data related to a certain location from a data provider and have them displayed on the device.

The WO 94/27268 concerns a portable information system that receives audio-visual information from a database. Used on a trip, this system can automatically identify and describe certain locations which may be of interest to the user. These include, for example, landmarks, the history of surrounding buildings, the location of hotels, hospitals, shops as well as products within a certain radius of the current position of the user. This system is operated using operating menus or using speech control.

A further document DE 44 37 360 A1 concerns a travel guide with a location-controlled information output. This device is designed in particular for the use of a GPS-controlled autopilot system in motor vehicles in combination with the provision of tourist information that is stored on CD ROM. Such a data output allows quick access to the desired information, which can also be provided acoustically. Furthermore, a portable device that is not restricted to motor vehicles is also proposed.

### BACKGROUND OF THE INVENTION

Methods and devices as described above are subject to quick development in the modern communication society. The up-to-date positioning of stationary and mobile objects is continuously gaining importance, both in private areas as well as for commercial use. Thus rough positioning, or navigation on long routes, is relatively easily possible using the known methods and devices, while accurate positioning, in particular in urban areas, has so far not been satisfactorily solved. Additional difficulties are found, for example in the reception of the required GPS data in canyon-like streets for determining one's position or even one's target with certainty.

The task of the invention at hand thus is to propose an improved method for accurately determining the position of geographical locations as well for defining the linkage of this data with further, for example commercial information in electronic form. With this, the user should on one hand be able to identify his target location with certainty, so that tedious and time-consuming searches for exact positions, for example at buildings, property access roads, parking lots, exposed objects and at not immediately obvious entrances or difficult-to-find locations are avoided. On the other hand, the geographical data should be linked with further information, so that a user receives quick information on product or service offers relating to his current position.

For a method as described above, this task is fulfilled using the features described in the main claim. Advantageous designs are provided in the subsequent claims.

According to the invention, the following procedural steps are carried out. At first, the position of the geographical measuring points of the suppliers participating in this method, i.e. the position of the measuring points of the participants' buildings, premises, objects, etc. are accurately determined and then the geographical coordinates corresponding to these measuring points are determined using a navigation and/or measuring system. In a next step, each measuring point is assigned with either a real or a virtual marker, whereby the assignment of a real marker is carried out by attaching a seal or similar on site and a virtual marker is created by electronic data or similar in the database. Following this, both the conventional, commonly used address data of these measuring points, if available, as well as the corresponding coordinates are stored in a database. Additionally, further, in particular commercial data, for example product and/or service information is stored in the database and linked with the already stored corresponding data of the measuring points. The data of the geographical measuring points and of the product and/or service information thus linked is then made available for use to a user by the service provider, whereby the user communicates with the database using a transmitting and receiving device. With the proposed method, a user is accurately guided to the desired location, which he can identify with certainty using the previously attached marker. Tedious and time-consuming searching and finding of exact positions, for example buildings, premises, parking lots or similar is thus advantageously avoided. Additionally, the user receives quick information on product and service offers linked to the local position of the current measuring point.

With the invention, the principle of “easy to search and exact to find” is provided quickly, comfortably and reliably in the local area; orientation is facilitated, localities and information are made transparent and the personal and commercial security is improved. The previously common search for a local address via the street address no longer takes place. The navigation using data provided by GPS, which until now has often been inadequate, is also improved. With the defined and direct assignment of markers to the interesting measuring points, for example a real estate, an exposed property or similar, the targeted locating of this position in reality is facilitated. The implementation of the method according to the invention therefore is multi-facetted and offers significant advantages in the identification of geographical measuring points using markers as well as economization of time, costs and route by the linkage to further information. With the products and services offered, the proposed method directly responds to the individual requirements of a user. It thus represents a navigation help, a marketing, rescue and control instrument, and a virtual planning tool in advantageous form and can also be used as a quality mark by integrating the marker into the corporate identity of a company.

In an advantageous further development of the invention, it is proposed that the geographical measuring points are attached in particular close to entrances, doors, gates, access roads, exposed positions or similar of buildings or properties. This allows accurate positioning of the location, which is indicated to the user, for example in front of the entrance of a building or a property, by the seal attached there by a service provider. It is thus also possible that a supplier, for example, can securely find the correct gate or the correct access road to a building or a property, even if the building or property has several access roads, which until now often have the same address or at least the same postal address. Exposed positions include, for example, tips of transmitter masts or roof edges and corners of high-rise buildings or similar.

In a further design of the invention, it is proposed that the position of a geographical measuring point is measured on site by the service provider using radio bearing or a cell measuring system with a satellite navigation system, for example GPS, DGPS (Differential Global Positioning System), GLO-NASS/GNSS (Global Navigation Satellite System) or a similar method, and that the predefined measuring point is then assigned with the corresponding geographic coordinates. In this way, any geographical measuring point, in particular when marked with a seal, is identifiable in an advantageous way by its geographic coordinates and can be combined with further data by entering this data in a database.

As an alternative to the above-named measuring method, which is carried out by performing on-site measurements, the position of a measuring point can also be determined by calculation, in case the measuring point is hard to access or not attainable. Advantageously, a virtual marker in electronic form is then available, for example in form of the coordinate data of the measuring point, which can then be stored and processed accordingly in the database. With today's high-precision real-time positioning systems, technical accuracies of 1 to 5 cm can be depicted, which in future can attain 1 cm and below using GPPS (Geodesic Precision Positioning System) and GHPS (Geodesic High-Precision Positioning System). It is thus ensured that the defined and marked measuring points can be accurately located.

According to the invention, several measuring points can be used to depict lines as well as surfaces or even spaces, which can be advantageously used for locating large buildings, properties, forests, sanctuaries, natural reserves or similar targets that do not dispose of a specific access point. If possible, the coordinates of each measuring point in the database are also assigned with the corresponding conventional address data, such as for example name, street address, city, country. The user can access these in the form of additional information on his location or target.

In an advantageous further development of the invention, it is proposed that a new kind of electronic address can be generated for each measuring point, for example composed of at least a part of the address data and/or the coordinates of the measuring point. In addition or as an alternative, the measuring point data can be converted to a barcode that would allow navigation devices in the future that are equipped with a barcode reader to store and associate the corresponding target address, an entrance or an access road. As an alternative, the electronic address can also be attached to mobile devices, such as for example navigation devices in a motor vehicle or to a cellular phone. Thus even mobile objects, persons or animals can be located. As an integrated component, the electronic address can supplement the previous address with street address, city, country or, in the long term, it can completely replace it.

The electronic address described above can, for example, also be entered into the navigation system of a vehicle. The system can then guide the driver directly to the desired location. The location, which is marked with a seal according to the invention, indicates the location of the entrance to the visitor. A problem that is currently very common, for example that the house number of a target building is hard to see for the driver, is thus solved. The method according to the invention supports targeted driving. Quick and comfortable locating, for example of parking spaces made available to visitors and guests, is thus made easily possible.

In an especially advantageous further development of the invention, which can also represent an invention on its own, it is proposed that the data of the measuring points is linked with further product and/or service information. These include, for example, tourist, logistical, meteorological, traffic-related, rescue-related, salvage-related, event information, purchasing/selling information, electronic maps such as e-maps or similar. There is thus an abundance of possible combinations for linking the geographical measuring points with additional information. It is also proposed to use the method according to the invention as a “fair guide”, which would, for example, guide visitors over the fair grounds and provide them with desired information or alternative access points to the fair. A visitor can thus also be guided through the fair city itself, and have the device guide him to certain locations, events or similar. A similar use as a “guide” is also possible, for example for Olympic Games, World Cups or similar events.

Further applications are thinkable, for example in public transportation, with the individual use of call-busses, also the search for parking spaces in urban areas as well as the locating of one's own vehicle on large parking lots. A large application field is also given in tourism, where places of interest, hotels, restaurants, inns or similar can be found more easily by the visitor using the method according to the invention.

In a further application of the method, it is proposed that offers for products that are critical in time, products with expiry dates, easily perishable products or services that are critical in time are included in the product and service information. This can include food as well as “just-in-time” deliveries of any nature or services fixed to a certain time.

The product and/or service information is supplied by the suppliers or by the service providers for everyday needs. These include, for example, pharmacies, bakeries, cafes, drugstores, retail traders, food stands, fast food restaurants, inns, wholesale traders, hotels, supply companies or similar, which are linked to the database and directly enter their information there.

The data of the measuring points and especially the data of the product and/or service information stored in the database is continuously maintained, updated and extended either directly by the suppliers or service providers or by a database provider service. This ensures that a customer who uses the information receives up-to-date or most recent information.

In a further development, it is proposed that in order to use the data stored in the database, the customer establishes a connection to this database using a stationary or instationary transmitting and receiving device. A cellular phone, a cellular phone with satellite navigation equipment, a wristwatch with satellite navigation equipment, a communication and navigation device in a motor vehicle, a PC, a notebook, a handheld computer, a palmtop computer or any similar electronic communication device can be used as the transmitting and receiving device. The connection from such a device to the database is established using data transfer via a conventional telephone network, radio, a cellular phone network, internet or similar.

The communication between a customer and the database advantageously takes place by the customer entering his requirements and wishes into the transmitting and receiving device. The entry is carried out, for example via menus or using speech control. Following this, the customer receives the desired coordinates and/or address data of his target from the database on his receiving device, together with corresponding product and/or service information.

For easy and comfortable communication with the database, the customer can select a defined program from a number of predefined software programs (query algorithms) using his transmitting and receiving device or can compile several defined programs.

Using a defined software program, a cost, route and time optimization, for example, can thus be carried out, depending on the requirements of the customer whether he, for example, wants to save costs during his shopping trip, would like to find the shortest route between individual targets or would like to reach the closest targets in the remaining time.

Using a defined software program, even desired products up to an upper price level specified by the customer, for example bargains, or products above a lower price level specified by the customer can be found. For example, the customer can thus specifically state that he wants to have special offers displayed.

Using a defined software program, the customer can also state that he wishes to have all product and/or service information displayed that is available within a defined area, which advantageously can be selected based on the customer's current location.

In an additional further development of the invention, it is proposed that the desired service information is compiled according to event type and event venue, using a defined software program. This includes, for example, opening times of shops, museums, public authorities, etc. as well as concerts, cinema events or similar.

The data requested by the customer and returned by the database, such as for example the address data, the geographic coordinates or the product and service information, can be displayed visually and/or given out acoustically by the receiving device. The customer will decide on this according to his individual requirements, depending on, for example, whether he can look at his receiving device or if he wishes to have the information given out acoustically, if he is driving a car, for example.

For a visual display, it is proposed that the customer is guided to or from the desired, marked location using vector guidance on an electronic map, for example an e-map, displayed on the transmitting and receiving device. For this, a marker, for example a miniaturized image of the seal on the electronic map, indicates the desired target location. This facilitates easy locating of the target.

In a further design, it is proposed that the products and/or services desired by the customer can be reserved from the supplier using the transmitting and receiving device. In this way, the method according to the invention can be used to reserve certain products as well as make hotel reservations, place advance ticket orders for a theater, cinema or similar.

Furthermore, it is proposed that when customers purchase a reserved product or service, they receive a rebate from the supplier participating in the method according to the invention. This advantageously creates a direct benefit for the customer as well as an incentive for frequently buying from suppliers that are connected with the method according to the invention.

By providing feedback on the sale of a product and/or a service to the database, the supplier can advantageously collect and evaluate sales data centrally.

### DETAILED DESCRIPTION

Further goals, features, advantages and designs of the invention are described in the following description of the embodiments, which are shown in more detail in the figures. All described and/or depicted features on their own or in any suitable combination with one another form the invention, independent of their summary in the claims and their referral to previous claims.

The figures show:

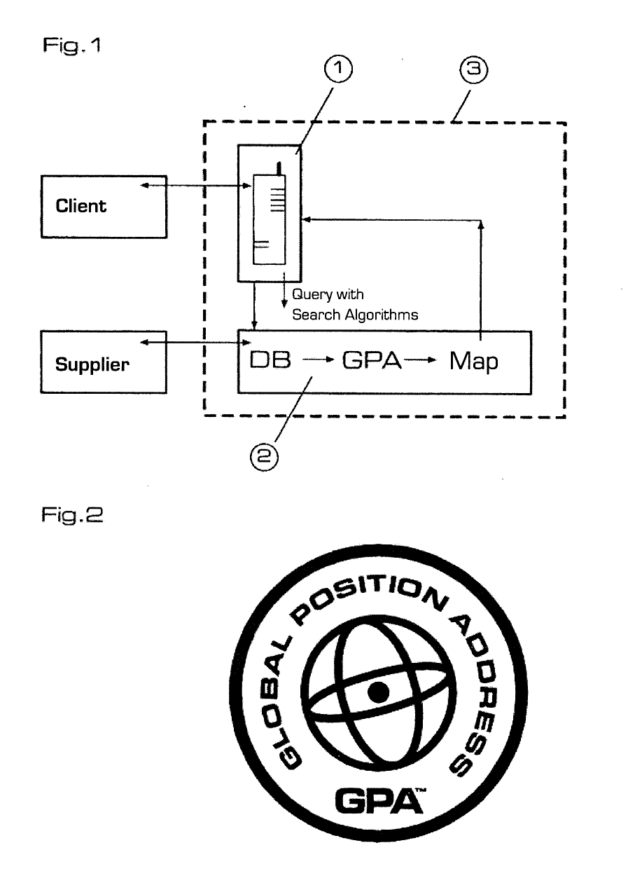

FIG. 1 a schematic depiction of the main functions of the method according to the invention,

FIG. 2 a seal for marking a measuring point in top view,

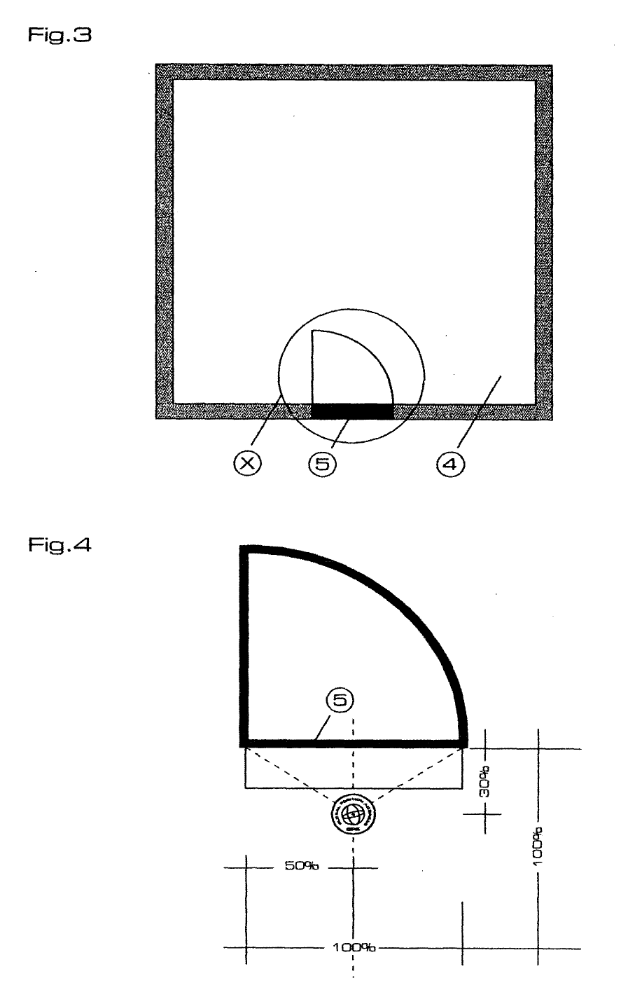

FIG. 3 the ground plan of a building with an entrance in schematic depiction and

FIG. 4 the entrance area according to detail X in FIG. 3 in enlarged view.

A customer (FIG. 1) uses the transmitting and receiving device (1) to query the information provided in the database (2) by a supplier. The database (2) supplies the customer with a map with an electronic address file GPA™ (Global Position Address) with the individual product and service information. For queries according to certain software programs, the transmitting and receiving device (1) sends an inquiry with search algorithms to the database (2), which then makes the desired data available to the customer via the transmitting and receiving device (1). The part of the method according to the invention is indicated by the system boundary (3). It contains the transmitting and receiving device (1) and the database (2) and is provided by a service provider.

A geographic measuring point can be marked, for example using a real marker such as a seal (FIG. 2). Such a seal-marker includes a GPA™-logo, for example.

In order to designate a measuring point (FIG. 3, FIG. 4), the width of an entrance (5), door, gate, access road or similar of a building (4) is determined. The measuring point is defined in the middle of the width with a perpendicular distance of preferably 30-100% of the width in front of the entrance (5). A customer can thus identify without doubt the entrance (5) of a building (4) marked with a seal. If the seal cannot be attached to the ground in front of an entrance (5) or access road, the seal can also be attached to the wall of a building immediately next to the entrance or access road. This seal is supplemented by a marker displaying the coordinates of the actual measuring point.

### SUMMARY

The invention describes a method for accurately determining the location of geographical measuring points and linking the data of these measuring points with further data as well as making the data thus linked available in electronic form. First, geographical measuring points are designated on site and the corresponding coordinates of these measuring points are determined. Following this, a real marker, for example in the form of a seal, or a virtual marker is assigned to each measuring point. The address data of the measuring points and the corresponding coordinates is then stored in a database. This data is supplemented with further commercial data, such as for example product and/or service information, and is made available for use to a client who communicates with the database using, for example, a transmitting and receiving device.

1. Method for accurately determining the location of geographic measuring points and linking the data of these measuring points with further data and the providing the data thus linked in electronic form, characterized by the following procedural steps:
Designation of the geographic measuring points and determination of the corresponding geographical coordinates of these measuring points using a navigation and/or measuring system,
Assignment of a real or virtual marker, for example a seal or the coordinate data, to the measuring point,
Storing of the measuring points' address data and the corresponding geographic coordinates in a database,
Storing of further data, such as for example product and/or service information in the database and linkage of this data with the corresponding data of the measuring points and
Making the data thus linked available for use by customers, whereby these communicate with the database using a transmitting and receiving device,

2. Method according to claim 1, characterized by the fact that the measuring points are attached close to entrances, doors, gates, access roads, exposed positions or similar of buildings or properties.

3. Method according to claim 2, characterized by the fact that the position of a measuring point is measured on site using a satellite navigation system, such as for example GPS, DGPS, GLONASS or similar, of a radio bearing or cell measuring system and the geographic coordinates are assigned to this measuring point.

4. Method according to claim 2, characterized by the fact that the position of a measuring point is determined by calculation.

5. Method according to one of the previous claims, characterized by the fact that the measuring point is made identifiable by attaching a real marker on site, for example a seal, or by assigning a virtual marker, for example in the form of electronic data information in the database.

6. Method according to one of the previous claims, characterized by the fact that several measuring points can be used to depict lines, surfaces or spaces.

7. Method according to one of the previous claims, characterized by the fact that the address data, for example name, street address, city, country and the corresponding coordinates of each measuring point are stored in the database.

8. Method according to one of the previous claims, characterized by the fact that an electronic address can be generated for each measuring point, which, for example, consists of a part of the address data and the coordinates of the measuring point.

9. Method according to one of the previous claims, characterized by the fact that for example tourist, logistical, meteorological, traffic-related, rescue-related, salvage-related, event information, purchasing and selling information and electronic maps such as e-maps or similar are intended as product and/or service information.

10. Method according to one of the previous claims, characterized by the fact that products critical in time, products with expiry date, easily perishable products or services critical in time or similar are intended as product and/or service information.

11. Method according to claim 9 or 10, characterized by the fact that the product and/or service information is supplied by suppliers or service providers for everyday needs, such as for example pharmacies, bakeries, cafes, drugstores, retail traders, food stands, fast food restaurants, inns, wholesale traders, hotels, restaurants, supply companies or similar.

12. Method according to one of the previous claims, characterized by the fact that the data of the measuring points and the product and/or service information stored in the database are continuously maintained and updated either directly by the suppliers themselves or by a database provider service.

13. Method according to one of the previous claims, characterized by the fact that in order to use the data stored in the database, the customer uses a stationary and/or instationary transmitting and receiving device, for example a cellular phone, a cellular phone with satellite navigation equipment, a wristwatch with satellite navigation equipment, a communication and navigation device in a motor vehicle, a PC, a notebook, a handheld computer, a palmtop computer or similar electronic communication device for establishing a connection to this database via conventional telephone network, radio, cellular phone network, internet or similar.

14. Method according to claim 13, characterized by the fact that the customer sends his requirements and/or wishes to the database using the transmitting and receiving device and the customer receives the desired product and/or service information from the database together with the corresponding coordinates and/or address data.

15. Method according to claim 14, characterized by the fact that, depending on his individual requirements, the customer can select at least one defined software program from a number of predefined software programs using the transmitting and receiving device.

16. Method according to claim 15, characterized by the fact that a defined software program carries out a cost, route and time optimization.

17. Method according to claim 15, characterized by the fact that a defined software program can provide desired products below an upper price level specified by the customer, for example bargains, or products above a lower price level specified by the customer.

18. Method according to claim 15, characterized by the fact that a defined software program can be used to provide the desired product and/or service information available within a defined radius, for example from the customer's current location.

19. Method according to claim 15, characterized by the fact that the desired products and/or services whose prices have been lowered can be provided using a defined software program.

20. Method according to claim 15, characterized by the fact that the desired service information can be compiled according to event type and event venue using a defined software program.

21. Method according to one of the previous claims, characterized by the fact that the data requested by the customer, such as for example the address data and/or the geographic coordinates and/or the desired product and/or service information and/or an electronic map is sent by the database and visually displayed and/or given out acoustically by the transmitting and receiving device.

22. Method according to claim 21, characterized by the fact that the customer is guided to or from the desired, marked location using vector guidance on an electronic map, for example an e-map, that is displayed on the transmitting and receiving device.

23. Method according to claim 22, characterized by the fact that the desired location is indicated on the map by a marker, for example a miniaturized image of the seal.

24. Method according to claim 21, characterized by the fact that the customer can be guided to or from the desired location that is marked, for example with a seal, using acoustic information from the transmitting and receiving device.

25. Method according to one of the previous claims, characterized by the fact that the desired products and/or services can be reserved from a supplier by the customer using the transmitting and receiving device.

26. Method according to claim 25, characterized by the fact that the customer receives a rebate from the supplier when purchasing a reserved product or service.

27. Method according to claim 25 or 26, characterized by the fact that the supplier sends feedback on the sale of a product or service to the database.
